(19) United States
(12) Patent Application Publication
(10) Pub. No.: US 2012/0048303 A1
(43) Pub. Date: Mar. 1, 2012

(54) PROCESS SYSTEM AND CLEANING PROCESS

(75) Inventors: Chi-Chen Lo, Hsinchu (TW); Shao-Chun Kuo, Hsinchu (TW); Ching-Wen Chen, Hsinchu (TW); Yen-Hui Su, Hsinchu (TW)

(73) Assignee: MACRONIX INTERNATIONAL CO., LTD., Hsinchu (TW)

(21) Appl. No.: 12/868,928

(22) Filed: Aug. 26, 2010

(51) Int. Cl. B08B 3/00

(52) U.S. Cl. 134/26; 134/94.1

(57) ABSTRACT

A process system includes a manufacture device, a concentration detector and a compensation device. The manufacture device is used for processing a wafer using a chemical solution. The concentration detector detects a concentration of a key component in the chemical solution. The compensation device provides a supplement solution to the manufacture device when the concentration of the key component in the chemical solution is lower than a definite value, wherein the supplement solution includes a component that is the same as the key component in the chemical solution.

### BACKGROUND

1. Field of Invention

The present invention relates to a process system and a cleaning process.

2. Description of Related Art

In a semiconductor manufacturing process, the cleanliness of a wafer is an important factor that affects the process yield, the device quality and reliability. In a wafer cleaning process, a chemical solution is normally used for the cleaning. The formulation in the chemical solution may gradually change with time due to consumption or evaporation. Hence, the process window narrows correspondingly. Typically, a chemical solution is often replaced with a fresh chemical solution for maintaining the cleaning quality so as to stabilize the process conditions. However, this approach is not cost efficient or environmentally friendly. Hence, the industry is interested in providing a chemical solution with the appropriate concentration, while environmental protection is also achieved.

### SUMMARY OF THE INVENTION

The present invention provides a process system, which may be applied for cleaning a wafer to enlarge the process window.

The present invention provides a process system, which may be applied for cleaning a wafer, wherein the replacement time lag of the cleaning solution may be extended to lower the usage amount of the chemical solution and to reduce cost, wherein the replacement time lag is the time period between the replacement or renewal of the chemical solution.

The present invention provides a cleaning process, in which the process window is increased.

The present invention provides a cleaning process, in which the replacement time lag of the chemical solution may be extended to lower the usage amount of the chemical solution and to reduce cost.

The present invention provides a process system that includes a manufacture device, a concentration detector and a compensation device. The manufacture device is suitable for processing a wafer using a chemical solution. The concentration detector is applicable for detecting the concentration of at least one key component in the above chemical solution after being used for processing the wafer. The compensation device is applicable for providing a supplement solution to the manufacture device when the concentration of the above key component in the chemical solution detected by the concentration detector is lower than a definite value, wherein the supplement solution includes a component that is the same as the key component in the chemical solution.

According to one exemplary embodiment of the invention, the above chemical solution includes a photoresist removal solution, and the above key component includes water.

According to one exemplary embodiment of the invention, the above chemical solution includes a cleaning solution, and the above key component includes NH₄OH or H₂O₂ or both.

According to one exemplary embodiment of the invention, the above manufacture device further includes a filter device for filtering the impurities in the above chemical solution after being used for processing the above wafer.

According to one exemplary embodiment of the invention, the above manufacture device further includes a reflux device for delivering the filtered chemical solution back to the manufacture device.

According to one exemplary embodiment of the invention, the above concentration detector is configured at a position suitable for detecting the concentration of the above key component in the above chemical solution in the reflux device or in the manufacture device.

According to one exemplary embodiment of the invention, the above manufacture device includes a processing tank and the above reflux device includes an external tank, a transport tube, and a delivering device. The external tank is configured at a periphery of the processing tank. The delivering device is used to deliver the chemical solution. The transport tube is connected with the external tank to transport the chemical solution in the external tank back to the processing tank.

According to one exemplary embodiment of the invention, the above concentration detector is disposed at a position suitable for detecting the concentration of the above key component in the above chemical solution in the processing tank, the above external tank or the above transport tube.

According to one exemplary embodiment of the invention, the above compensation device delivers the above supplement solution to the above external tank, and then to the above manufacture device through the above transport tube.

According to one exemplary embodiment of the invention, the above reflux device further includes a temperature controller, which is disposed in the proximity of the transport tube for controlling the temperature of the above chemical solution.

The present invention provides a cleaning process, wherein this process uses a chemical solution for processing a wafer. The above cleaning process further includes detecting the concentration of a key component in the chemical solution during or after the cleaning process. When the concentration of the above key component is lower than a definite value, a supplement solution is added, wherein the supplement solution contains a component that is the same as the key component in the chemical solution, such that the concentration of the above key component in the above chemical solution is increased to the above definite value or higher.

According to one exemplary embodiment of the invention, the above the above chemical solution includes a photoresist removal solution, and the above key component includes water.

According to one exemplary embodiment of the invention, the above chemical solution includes a cleaning solution, and the above key component includes NH₄OH or H₂O₂ or both

According to one exemplary embodiment of the invention, wherein the chemical solution is replaced after the process has been performed for a certain time period.

According to one exemplary embodiment of the invention, the above process system may be used for cleaning a wafer to enlarge the process window.

According to one exemplary embodiment of the invention, the above process device is used for cleaning wafer, in which the replacement time lag of the chemical solution may be extended to lower the usage amount of the chemical solution and to reduce cost.

According to one exemplary embodiment of the invention, the above cleaning process may enlarge the process window.

According to one exemplary embodiment of the invention, the above cleaning process may extend the replacement time lag of the chemical solution to lower the usage amount of the chemical solution and to reduce cost.

It is to be understood that both the foregoing general description and the following detailed description are exemplary, and are not intended to limit the scope of the invention.

### BRIEF DESCRIPTION OF THE DRAWINGS

FIG. 1 is a schematic diagram illustrating a process system according to one exemplary embodiment of the present invention.

### DESCRIPTION OF EMBODIMENTS

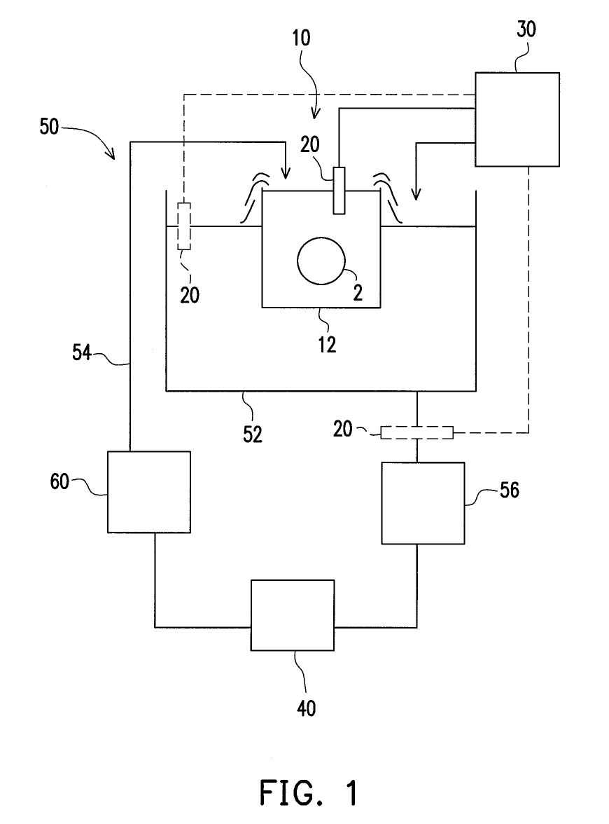

FIG. 1 is a schematic diagram illustrating a process system according to one exemplary embodiment of the present invention.

Referring to FIG. 1, the process system 100 includes a manufacture device 10, a concentration detector 20 and a compensation device 30.

The manufacture device 10 is suitable for processing a wafer 2 using a chemical solution. In one exemplary embodiment, the manufacture device 10 is a wet cleaning station, which includes a processing tank 12. The processing tank 12 is, for example, an overflow tank. The manufacture device 10 may also include a filter device 40, a reflux device 50 and a temperature controller 60.

The filter device 40 is for filtering impurities, for example, the by-products on the wafer, in the chemical solution after being used to process the wafer 2.

The reflux device 50 is used to transport the filtered chemical solution back in the manufacture device 10. In one exemplary embodiment, the reflux device 50 includes an external tank 52, a transport tube 54 and a delivering device 56. The external tank 52 is configured at the periphery of the processing tank 12 and is used for carrying overflow the chemical solution from the processing tank 12. The transport tube 54 and the external tank 52 are connected. The transport tube 54 is used for transporting the chemical solution in the external tank 52 to the processing tank 12 via the delivering device 56; hence, the chemical solution could be recycled and reused. The delivering device 56 is, for example, a pump.

The temperature controller 60 is, for example, a heater, which is disposed in the proximity of the transport tube 54. The temperature controller 60 is used to control the temperature of the chemical solution.

The concentration detector 20 is used for detecting the concentration of at least one key component in the chemical solution after being used to process the wafer 2. The concentration detector 20 also sends the information of the detected concentration to the compensation device 30.

The chemical solution after being used to process the wafer 2 could be the chemical solution in the processing tank 12, the chemical solution in the external tank 52 or the chemical solution in the transport tube 54. The concentration detector 20 is, for example, a concentration meter. The key component detected by the concentration detector 20 refers to the component of the chemical solution that has a very important effect on the processed wafer. When the component having very important effect on the processed wafer includes only one species, the key component is also one species. When the component having very important effect to the processed wafer includes two species, the key components may be one species or two species.

The compensation device 30 may receive the concentration information of the key component detected by the concentration detector 20. When the received concentration information indicates that the concentration is lower than a definite value, the amount that is required to be compensated is calculated. The compensation device 30 may then provide a supplement solution containing a component that is the same as the key component to the manufacture device 10 to compensate the concentration of the key component in the chemical solution. In one exemplary embodiment, the compensation device 30 may deliver the supplement solution to the external tank 12 first, and then to the manufacture device 10 through the transport tube 54. In one exemplary embodiment, the compensation device 30 may deliver the supplement solution directly to the manufacture device 10 (not shown). In another exemplary embodiment, the compensation device 30 may deliver the supplement solution to the manufacture device 10 via the transport tube 54 (not shown).

In another specific exemplary embodiment, the chemical solution is, for example, a photoresist removal solution, and the composition of a photoresist removal solution includes, for example, hydroxylamine, monoethanolamine, isopropanol amine, and water, etc. The photoresist removal solution includes, for example, the product EKC produced by DuPont Company. For example, the key component in the product EKC produced by DuPont Company includes water. When the water content containing in the photoresist removal solution becomes insufficient due to consumption or evaporation with time, the concentrations of other components in the photoresist removal solution become relatively too high. As a result, the process conditions change and the problem of narrowing process window arises. The concentration detector 20, for example, a concentration meter produced by a U.S. company Jetalon, may be used to detect the water content in the photoresist removal solution. The supplement solution provided by the compensation device 30 includes water or EKC. In another exemplary embodiment, the supplement solution provided by the compensation device 30 only includes water. The supplemented amount of water allows the water content in the photoresist removal solution to increase to a definite value or higher. In one exemplary embodiment, the definite value of the water content in the photoresist removal solution is 15% by weight; in another exemplary embodiment, the definite value of the water content is 17% by weight; in yet another exemplary embodiment, the definite value of the water content is 13% by weight. It should be noted that the invention is not limited as such. The concentration of the key ingredient in the chemical solution may be set according to the actual requirement.

In another specific exemplary embodiment, the chemical solution may contain NH₄OH and H₂O₂, for example, a SCI cleaning solution. The composition of the SCI cleaning solution is NH₄OH:H₂O₂:H₂O=1:1:5. The key component includes NH₄OH and/or H₂O₂. When NH₄OH and/or H₂O₂ in the SCI cleaning solution is consumed with time, and the concentration of NH₄OH and/or H₂O₂ in the SCI cleaning solution becomes insufficient, the process condition changes, leading to the problem of poor process yield. The concentration detector 20 may be used to detect the content of NH₄OH and/or H₂O₂ in the SCI cleaning solution, and the concentration detector 20 is a concentration meter produced by Jetalon of the United States. The supplement solution provided by compensation device 30 may contain NH₄OH and/or H₂O₂. In other words, the supplement solution provided by the compensation device 30 may contain NH₄OH only, or H₂O₂ only, or a NH₄OH and H₂O₂ aqueous solution having a concentration no less than that in an original SCI cleaning solution. The supplemented amount of NH₄OH and/or H₂O₂ allows the content of NH₄OH and/or H₂O₂ in the SCI cleaning solution to increase to the definite value or higher. In one exemplary embodiment, the definite value of the NH₄OH content is 13.5% by weight and the definite value of the H₂O₂ content is 13.5% by weight. It should be noted that the invention is not limited as such. The concentration of the key ingredient in the chemical solution may be set according to the actual requirement.

According to the cleaning process of an exemplary embodiment of the invention, during or after the processing of the wafer 2 with the chemical solution, the concentration of at least one key component in the chemical solution is detected. When the concentration of the key component is lower than a definite value, a supplement solution is added, wherein the supplement solution contains a component that is the same as the key component, such that the concentration of the key component in the chemical solution may increase to the definite value or higher. The above-mentioned detection and supplement solution addition steps may be repeated to further renew the chemical solution.

In accordance to the above exemplary embodiments of the invention, the concentration controller and the compensation device, and the manufacture device form a full closed-loop control system. By adding the key component, the concentration of the key component in the chemical solution is compensated. Hence, the composition of the chemical solution of the device may remain stable. Further, the process stability is maintained to enlarge the process window. Moreover, the replace time-lag of the chemical solution in the exemplary embodiments of the invention could be twice of that of the conventional chemical solution. Not only the amount of the chemical solution being used is lower, the purpose of environmental protection is achieved and the production cost is reduced.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A process system, comprising:
a manufacture device, for processing a wafer using a chemical solution;
a concentration detector device, for detecting a concentration of at least one key component in the chemical solution after being used to process the wafer; and
a compensation device, for providing a supplemented amount of a supplement solution to the manufacture device when the concentration of the key component detected by the concentration detector is lower than a definite value, wherein the supplement solution contains a component that is the same as the key component.

2. The process system of claim 1, wherein the chemical solution comprises a photoresist removal solution, and the key component comprises water.

3. The process system of claim 1, wherein the chemical solution comprises a cleaning solution, and the key component comprises NH₄OH or H₂O₂ or NH₄OH and H₂O₂.

4. The process system of claim 1 further comprising a filter device, for filtering impurities in the chemical solution after being used to process the wafer.

5. The process system of claim 4 further comprising a reflux device for transporting the filtered chemical solution back to the manufacture device.

6. The process system of claim 5, wherein the concentration detector is configured at a position for detecting the concentration of the key component in the chemical solution in the reflux device or in the manufacture device.

7. The process system of claim 6, wherein the manufacture device comprises a processing tank, and the reflux device comprises:
an external tank, configured at a periphery of the processing tank;
a transport tube, connected with the external tank, for transporting the chemical solution from the external tank back to the processing tank; and
a delivering device, for delivering the chemical solution.

8. The process system of claim 7, wherein the concentration detector is configured at a position for detecting the concentration of the key component in the chemical solution in the processing tank, the external tank or the transport tube.

9. The process system of claim 7, wherein the compensation device delivers the supplement solution to the external tank and then to the manufacture device through the transport tube.

10. The process system of claim 7, wherein the reflux device further comprises a temperature controller, configured proximal to the transport tube.

11. A cleaning process that applies a chemical solution to process a wafer, the cleaning process comprising:
detecting a concentration of at least one key component in the chemical solution during or after the cleaning process; and
adding a supplement solution when the concentration of the detected key component is lower than a definite value, wherein the supplement solution contains a component that is the same as the key component, such that the concentration of the key component in the chemical solution is increased to the definite value or higher.

12. The cleaning process of claim 11 wherein the chemical solution comprises a photoresist removal solution, and the key component comprises water.

13. The cleaning process of claim 11, the chemical solution comprises a cleaning solution, and the key component comprises NH₄OH or H₂O₂ or both NH₄OH and H₂O₂.

14. The cleaning process of claim 11 further comprising repeating the step of detecting the concentration of the at least one key component in the chemical solution and the step of adding the supplement solution.
